(19) United States
(12) Patent Application Publication
(10) Pub. No.: US 2025/0041035 A1
(43) Pub. Date: Feb. 6, 2025

(54) DENTAL CLEANING APPLIANCE AND COMPONENTS THEREOF

(71) Applicant: Dyson Technology Limited, Malmesbury, Wiltshire (GB)

(72) Inventor: Harvey Dylan CUMMING, Singapore (SG)

(21) Appl. No.: 18/710,800

(22) PCT Filed: Nov. 4, 2022
(86) PCT No.: PCT/GB2022/052788

§ 371 Date: May 16, 2024

(30) Foreign Application Priority Data
Nov. 17, 2021 (GB) 2116575.8

(51) Int. Cl. A61C 17/22; A46B 5/00

(52) U.S. Cl. CPC A61C 17/22; A46B 5/00; A46B 2200/1066

(57) ABSTRACT

A cleaning tool head for a dental cleaning appliance is described that includes an imaging sensor and the cleaning tool head. The cleaning tool head further includes a lens cover, wherein an outer surface of the lens cover includes a first curved surface portion.

### FIELD OF THE INVENTION

The present invention relates to a cleaning tool head for a dental cleaning appliance, and a dental cleaning appliance incorporating the cleaning tool head.

### BACKGROUND

Various systems comprising a camera for oral inspection are known (sometimes referred to as ‘dental intra-oral camera systems’). These devices are generally used for imaging of the teeth, gums, or other oral structures of a patient in a medical setting. These devices are typically not suitable for use at the same time as a dental cleaning process is being performed-rather they are intended for substantially ‘dry’ use.

However, it has recently been realised that it may be desirable to be able to provide dental or oral imaging via e.g. a typical dental cleaning appliance intended for use in a dental cleaning process. Such dental cleaning appliances generally comprise a cleaning tool head which is connected to a dental cleaning appliance body including a handle. The cleaning tool head may be a brush head, for example comprising a stem and a head portion bearing bristles for brushing teeth. Incorporation of an intra-oral imaging system into such a dental cleaning appliance may offer a number of advantages. For example, EP3294197A1 discloses an arrangement in which a dental cleaning appliance having a fluid delivery system is configured to actuate the delivery of a working fluid to the teeth of the user automatically depending on the magnitude of an output from a sensor, when it is detected that the nozzle of the fluid delivery system is located within an interproximal gap. However, this publication does not provide specific information on the location or form of the camera.

One problem that must be overcome when providing a system which allows for dental imaging even during a dental cleaning process is that in the environment of a user's mouth, and in particular during a dental cleaning process, multiple obscuration mediums may be present: for example, water, salvia, toothpaste and foam. If a region of interest (ROI) of the sensor becomes fully or partially obscured by such an obscuration medium, it may not be possible for the sensor to provide a clear image.

Accordingly, it would be desirable to provide a dental cleaning appliance capable of providing improved dental oral imaging in comparison to known systems, and in particular, being capable of providing imaging with reduced obscuration of a ROI of a camera in comparison to known arrangements, when the appliance is in use in a user's mouth.

The present invention has been devised in light of the above considerations.

### SUMMARY OF THE INVENTION

Accordingly, in a first aspect, there is provided a cleaning tool head for a dental cleaning appliance, the cleaning tool head comprising a lens cover, wherein an outer surface of the lens cover comprises a first curved surface portion.

The term “lens cover” is used herein to define a substantially translucent or transparent element which is arranged to overlay an imaging sensor. The lens cover may provide physical protection for the imaging sensor. As an outer surface of the lens cover comprises a first curved surface portion, it may act to focus or disperse light rays to an extent and accordingly in in some places through this description, it may alternatively be referred to simply as a “lens”.

It has been found that by providing a cleaning tool head having a lens cover wherein at least a part of the lens cover comprises a curved surface portion in this manner, that unwanted obscuration of the lens cover by obscurants such as water, salvia, toothpaste and foam can be reduced or avoided during use. In particular, unwanted obscuration of the lens cover by obscurants such as water, salvia, toothpaste and foam can be reduced or avoided in comparison to arrangements where lenses or lens covers having alternative geometries are used (for example, in comparison to a flat lens or flat lens cover).

The term “curved surface portion” is used herein to define a portion of the surface that is curved in at least one direction. In other words, at least one principle curvature of the curved surface portion is greater than zero.

In some arrangements, one of the principle curvatures of the curved surface portion may be equal to zero. In other words, the curved surface portion may be a cylindrical surface portion. However, in preferred arrangements, the principle curvatures of the curved surface portion are both greater than zero. In other words-the curved surface portion may be curved in two orthogonal directions and define a convex ellipsoid. Where the principle curvatures of the curved surface portion are both greater than zero, the curved surface portion may alternatively be referred to as a ‘domed surface portion’. Such arrangements may be more effective in preventing stagnation of obscurants on the lens cover during use in comparison to arrangements where one of the principle curvatures of the curved surface portion is equal to zero (wherein the curved surface portion is a cylindrical surface portion).

In more preferred arrangements, the principle curvatures of the curved surface portion may be equal to one another. In other words-the curved surface portion may be a substantially spherical surface portion. It has been found that provision of a portion of the outer surface of the lens cover that is spherical in shape may be particularly advantageous for reducing or eliminating unwanted obscuration of the lens cover during use of the cleaning tool head. However, it is not essential that the principle curvatures are equal to one another. In some arrangements, the principle curvatures of the outer surface of the lens cover may not be equal. In such cases, the domed surface portion will constitute a non-spherical convex ellipsoid.

At least one radius of curvature of the curved surface portion may be in a range of from about 1.5 to about 4.5 mm. For example, at least one radius of curvature of the curved surface portion may be 1.5 mm or more, 2 mm or more, 2.5 mm or more, or 3 mm or more. It may be 4.5 mm or less, 4 mm or less, 3.5 mm or less or 3 mm or less. In preferred arrangements, at least one radius of curvature of the curved surface portion may be in a range of from 2 mm to 3 mm. More preferably, at least one radius of curvature of the curved surface portion may be about 2.5 mm. When the radius of curvature is small (i.e. less than 1.5 mm), optical distortion through the lens may be undesirably large. However, when the radius of curvature is larger, the obscuration run-off may be less effective. Accordingly, the radius of curvature is preferably selected to balance these two factors. The range of about 1.5 to about 4.5 mm has been found to be suitable in this regard.

Providing a curved surface portion having a smaller radius of curvature may improve clearing of obscurants off the surface of the lends cover. However, it may also increase the optical distortion through the lens cover. The choice of the curvature of the lens cover should therefore be selected to balance the advantages of improved clearing off the surface and maintaining an allowable optical distortion through the lens.

The same considerations also apply when the curved surface portion is a domed surface portion which is curved in at least two directions. Where the curved surface portion is a domed surface portion, both of the principle radii of curvature may be in a range of from 1 to 5 mm. For example, both of the principle radii of curvature of the curved surface portion may be 1 mm or more, 1.5 mm or more, 2 mm or more, 2.5 mm or more, or 3 mm or more. It may be 5 mm or less, 4.5 mm or less, 4 mm or less 3.5 mm or less or 3 mm or less. In preferred arrangements, both of the principle radii of curvature of the domed surface portion may be in a range of from 2 mm to 3 mm. As discussed above, the principle radii of curvature may be equal to one another. Alternatively, they may be different to one another. In one preferred arrangement, both of the principle radii of curvature of the domed surface portion may be about 2.5 mm.

In some arrangements, the lens cover may comprise a second curved surface portion immediately adjacent to the first curved surface portion, wherein the principle curvatures of the first curved surface portion differ from the principle curvatures of the second curved surface portion. Where a second curved surface portion is provided immediately adjacent to the first curved surface portion, the same considerations relating to the radius of curvature of the second curved surface portion as set out above in relation to the first curved surface portion may apply. The second curved surface portion may be a cylindrical surface portion, a domed surface portion, or a spherical surface portion.

In one preferred arrangement, the first curved surface portion comprises a domed surface portion, and the second curved surface portion comprises a cylindrical surface portion. In such an arrangement, the longitudinal axis of the cylindrical surface portion may be aligned with, or substantially parallel to, a central longitudinal axis of the cleaning tool head. The length of the cylindrical portion (as measured in a direction parallel to a longitudinal direction of the cleaning tool head), is not particularly limited, but may be e.g. 0.2 mm or more, 0.5 mm or more, 1 mm or more, 1.5 mm or more, or 2 mm or more. In some preferred arrangements, the length of the cylindrical surface portion may be around 1.4 mm long.

The present inventors have found that offering first and second curved surface portions adjacent to one another, where the curvatures of the first and second portions differ, can act to provide bias clearing paths for obscurants across the outer surface of the lens cover.

For example, providing a cylindrical surface portion next to a domed surface portion may be particularly advantageous, as the cylindrical surface portion acts to provide a “route of least resistance” for obscurants travelling away from the domed surface portion of the lens cover. In some arrangements, the geometry of the lens cover may result in some volume of obscurant stagnating on the cylindrical surface portion away from the domed surface portion, thereby allowing for enhanced clearing of the domed surface portion of the lens cover.

As discussed above, the lens cover is a substantially translucent or transparent element. The material of the lens cover is not particularly limited. However, it may conveniently be formed from a glass (e.g. a silicate glass), or a polymer. Glasses may offer advantages including greater resistance to physical damage such as scratches, although may require simplification of the lens geometry. Polymers may offer advantages including ease of manufacture, and low cost. Preferably, the lens cover is formed from nylon, polycarbonate, or PMMA.

In some arrangements, one or more surface coating may be provided on the lens cover. For example, a hydrophilic or hydrophobic surface coating may be provided. Preferably, the lens cover comprises a hydrophilic coating having a contact angle of 60° or less, 50° or less, 40° or less, or 30° or less. Super-hydrophilic coatings having a contact angle of 30° or less may be preferred, as creating a very low contact angle for fluid on the surface of the cover can help in preventing obscuration of the lens cover.

The specific form of the cleaning tool head is not particularly limited. The cleaning tool head may be configured to perform one or more dental cleaning processes. In preferred arrangements, the cleaning tool head may comprise a brush head comprising bristles or other elements for brushing teeth.

In preferred arrangements, the cleaning tool head may comprise a head portion and a stem portion, wherein the stem portion is configured for connection to the body of a dental cleaning appliance.

The precise arrangement of the lens cover on the cleaning tool head is not particularly limited. Where the cleaning tool head comprises a head portion and a stem portion, the lens cover may be provided on either of these portions. It may be preferred for the lens cover to be provided on a stem portion of the cleaning tool head, to avoid obscuration of the lens cover e.g. by flexion of bristles or other members present as part of the head portion, and to reduce the risk of impingement of the lens cover on a user's teeth during use.

The lens cover may be offset from a central longitudinal axis of the cleaning tool head e.g. by virtue of being provided on a surface of the cleaning tool head. The height of the lens cover at any given point may be given as the distance in a radial direction between a central longitudinal axis of the cleaning tool head and an outer surface of the lens cover. The height of the lens cover may vary along its length or its width.

The height of the lens cover can also be considered in relation to the centre of movement of the cleaning tool head, where the cleaning tool head is configured to have one or more of a reciprocating, oscillating, vibrating, pivoting or rotating motion applied to the cleaning tool head when in use (e.g. applied by a dental cleaning appliance body). In particular, for arrangements where a dental cleaning appliance is operable to apply vibration to the cleaning tool head, it may be particularly useful to consider the height of the lens cover with respect to the centre of vibration of the cleaning tool head, as a radial velocity at the outer surface of the lens cover (e.g. on rotational/sinusoidal vibration of the cleaning tool head) will increase with increasing height of the lens cover (as (v=ωr))). The centre of movement (e.g. the centre of vibration) of the cleaning tool head may be substantially the same as the central longitudinal axis of the cleaning tool head, in which case the height of the lens cover with respect to the central longitudinal axis of the cleaning tool head will be the same as the height of the lens cover with respect to the centre of movement (e.g. centre of vibration) of the cleaning tool head. Alternatively, the centre of movement may be offset from the central longitudinal axis of the cleaning tool head by an offset amount, in which case the height of the lens cover with respect to the centre of movement will be different to the height with respect to the central longitudinal 25 axis, by said offset amount. The offset amount will typically be in a range of from 0 to 3 mm, for example 0.1 mm, 0.2 mm, 0.3 mm, 0.4 mm, 0.5 mm, 0.6 mm, 0.7 mm, 0.8 mm, 0.9 mm, 1 mm, 1.5 mm, 2 mm, 2.5 mm or 3 mm.

The maximum height of the lens cover with respect to a central longitudinal axis of the lens cover, or with respect to a centre of movement of the lens cover, may be in a range of from 3 to 7 mm. The minimum height will typically be a height greater than a radius of the cleaning tool head itself, so that the lens cover protrudes from the surface of the cleaning tool head. In one example arrangement, the radius of a stem portion of the cleaning tool head on which the lens cover is located is 4.8 mm, and so the minimum height of the lens cover is around 5 mm or more. Preferably, the maximum height of the lens cover may be in a range of from about 5-7 mm, more preferably about 6-6.5 mm. The maximum height of the lens cover with respect to a central longitudinal axis of the lens cover may be measured as the distance, in a radial direction, between a central longitudinal axis of the cleaning tool head and a radially outermost point of the outer surface of the lens cover. The maximum height of the lens cover with respect to a centre of movement (e.g. a centre of vibration) of the lens cover may be measured as the distance, in a radial direction, between the centre of movement of the cleaning tool head and a radially outermost point of the outer surface of the lens cover. The point of maximum height of the lens cover may be located on the curved surface portion of the lens cover.

An ‘offset height’ of the lens cover may also be considered, which may be measured as the distance between the central longitudinal axis of the cleaning tool head and the centre of curvature of the first curved surface portion. This offset height is not particularly limited, although, as will be well understood, it may be less than the maximum height of the lens cover by a value equal to the radius of curvature of the first curved surface portion. The offset height may therefore be in a range of from about 1 mm to about 5 mm, more preferably from about 2 to 4 mm. In some preferred arrangements, the offset height may be around 3.6 or 3.75 mm.

Increasing the height of the lens cover may be advantageous, as a radial velocity at the outer surface of the lens cover (e.g. on rotation of the cleaning tool head) will increase with increasing height of the lens cover (as (v=ωr)). This advantage is particularly pronounced for arrangements where the cleaning tool head is configured to be vibrated when in use (discussed below). Providing greater radial velocity of an outer surface of the lens cover on rotation of the cleaning tool head can encourage obscurant run-off, thereby helping to reduce or avoid stagnation of obscurants on the outer surface of the lens cover.

However, as the height of the lens cover is increased, the likelihood of clashing of the lens cover with a user's teeth when in use may also increase. Accordingly, the value of the height of the lens cover (and in particular, the height of the lens cover at the curved surface portion) may be selected to balance radial velocity at the outer surface of the lens cover, and the likelihood of tooth clashing during use.

Where the cleaning tool is a brush head comprising bristles or other elements for brushing teeth, the maximum height of the lens cover is preferably less than the height of the bristles or elements at maximum deflection. This can further reduce the likelihood of clashing of the lens cover with a user's teeth when in use.

The lens cover may be attached to the cleaning tool head by any suitable method. For example it may be attached by one or more of: an adhesive, ultrasonic welding, laser welding, or an attachment structure. Laser welding may be most preferred, as can offer a fast and convenient method for forming a suitable bond between the lens cover and a body of the cleaning tool head.

In some arrangements, the lens cover may be provided as part of, or attached to, a lens cover body. The lens cover body may allow for more convenient attachment of the lens cover to the cleaning tool head without the risk of damaging or obscuring the lens cover itself during the attachment process. The precise shape of the lens cover body is not particularly limited. In some arrangements the lens cover body may be generally plate like in form. In other arrangements, the lens cover body may comprise a moulded body.

In typical use, the cleaning tool head may be attached to, or provided as part of, a dental cleaning appliance.

Accordingly, in a second aspect, the present invention provides a dental cleaning appliance comprising:
a body;
an imaging sensor having a field of view (FOV); and
a cleaning tool head according to the first aspect of the invention.

The body of the dental cleaning appliance may comprise a handle portion. The handle portion may be configured to be gripped by a user during use of the dental cleaning appliance.

The cleaning tool head may be attached to, or attachable to, the dental cleaning appliance body. The cleaning tool head is preferably detachably connectable to the dental cleaning appliance body. This can allow for regular replacement of the cleaning tool head by a user of the dental cleaning appliance, e.g. due to wear of bristles or other parts of the cleaning tool head. For example, each of the cleaning tool head and the dental cleaning appliance body may comprise respective connector portions configured for removable connection of the dental cleaning appliance body and the cleaning tool head. The dental cleaning appliance body may comprise a male connector, for example in the form of a pin or spigot, which is configured to be received by a complementary female connector, for example in the form of a recess, provided on the cleaning tool head, to allow for removable connection of the cleaning tool head and the dental cleaning appliance.

However, providing for removable connection of the dental cleaning tool appliance body and the cleaning tool head is not essential-it is contemplated that in some arrangements, the cleaning tool head may be fixed relative to, or integral with, the dental cleaning appliance body.

The precise form of the imaging sensor is not particularly limited, and any suitable imaging sensor may be used. The location of the imaging sensor on the dental cleaning appliance is also not particularly limited. In some arrangements, the imaging sensor may be provided on, or as part of, the cleaning tool head. In other arrangements, the imaging sensor may be provided on, or as part of, the dental cleaning appliance body. Providing the imaging sensor on, or as part of, the dental cleaning appliance body may be preferred over providing the imaging sensor on the cleaning tool head, as this can allow the overall cost of the cleaning tool head to be reduced, as the number of electronic component parts of the cleaning tool head can be reduced. This is advantageous as the cleaning tool head may be regularly replaced by a user of the dental cleaning appliance.

In one preferred arrangement, the imaging sensor is disposed within a spigot portion of the dental cleaning appliance body. In such arrangements, the portion of the cleaning tool head comprising the lens cover may be configured to overlay the imaging sensor, when the cleaning tool head is attached to the dental cleaning appliance body.

In other arrangements, the portion of the cleaning tool head comprising the lens cover may be configured to overlay an imaging component such as a fibre optic cable, or optical prism, which is arranged to convey light to the imaging sensor. For example, the imaging sensor itself may be located away from the lens cover, for example in a body portion of the dental cleaning appliance, but may be arranged to receive light via a fibre optic cable or optical prism located beneath the lens cover, e.g. in a spigot portion of the dental cleaning appliance.

In some arrangements, a region of interest (ROI) is defined within the field of view (FOV) of the sensor. The ROI may be smaller than the field of view of the sensor. For example, the ROI may be 90% or less, 80% or less, 70% or less, 60% or less, 50% or less, 40% or less or 30% or less of the area of the FOV. In some arrangements, the ROI may be at least 5%, or at least 10% of the area of the FOV. The ROI may be approximately centrally located in the FOV. Alternatively, the ROI may be offset from the centre of the FOV. The precise selection of the ROI may depend on the intending imaging function of the imaging sensor.

The lens cover of the cleaning tool head may be arranged to overlay the imaging sensor such that at least a part of a region of interest (ROI) of the imaging sensor intersects at least a part of a curved surface portion of the lens cover. For arrangements where the imaging sensor is provided as part of the dental cleaning appliance body. e.g. on a spigot portion of the body, this may only be the case when the cleaning tool head is attached to the dental cleaning appliance body.

The present inventors have found that by arranging the lens cover to overlay the imaging sensor such that at least a part of the ROI intersects at least a part of a curved surface portion of the lens cover, unwanted obscuration of the lens cover by obscurants within the ROI can be reduced or avoided during use.

In some arrangements, the entire ROI may intersect a curved surface portion of the lens cover. In other words, the ROI may lie entirely within said curved surface portion of the lens cover. This can further reduce the incidence of obscuration of the ROI during use of the cleaning tool head.

The dental cleaning appliance may further comprise a light source arranged for illumination of at least part of the field of view of the imaging sensor. Where a ROI is defined within the FOV, the light source may be arranged for illumination of the ROI of the imaging sensor This may be advantageous, as a user's mouth may not otherwise be well illuminated enough to provide suitable light conditions for imaging. Providing a light source as part of the device can improve imaging quality without a requirement for external illumination during imaging.

Where a light source is provided, this may be provided as on, or as part of, the cleaning tool head. In other arrangements, the light source may be provided on, or as part of, the dental cleaning appliance body. Providing the light source on, or as part of, the dental cleaning appliance body may be preferred over providing the light source on the cleaning tool head, for the same reasons as discussed above in relation to the location of the imaging sensor. In one preferred arrangement, the light source is disposed within a spigot portion of the dental cleaning appliance body.

The light source may be a single point light source. For example, the light source may be a single LED. Use of a single point light source such as a single LED can minimise the space taken up by the light source. This is particularly advantageous in arrangements where the light source is provided on a spigot portion of the dental cleaning appliance body. Furthermore, the use of a single point light source can reduce the amount of heat generated by the light source (in comparison to a multiple-point source). This may be particularly advantageous where the light source is located near, or adjacent to the imaging sensor, to prevent overheating of the device.

The dental cleaning appliance may be operable to apply one or more of a reciprocating, oscillating, vibrating, pivoting or rotating motion to the cleaning tool head. For example, the dental cleaning appliance body may comprise a motor which is operable to apply the reciprocating, oscillating, vibrating, pivoting or rotating motion to the cleaning tool head. The motor may be arranged to be driven by a power source, such as a battery, provided in the dental cleaning appliance body

It is generally well-known to provide dental cleaning appliances which are operable to apply such movements to a cleaning tool head in this way, for the purposes of imparting a brushing portion to bristle or other elements provided on the cleaning tool head for brushing teeth. However, in the context of the present invention, it has also been found that applying reciprocating, oscillating, vibrating, pivoting or rotating motion to the cleaning tool head has an additional advantage of assisting in the clearing of obscuration from the lens cover during use.

Preferably, the dental cleaning appliance is operable to apply sinusoidal vibration to the cleaning tool head. The centre of vibration may lie along a longitudinal central axis of the cleaning tool head.

The invention includes the combination of the aspects and preferred features described except where such a combination is clearly impermissible or expressly avoided.

### SUMMARY OF THE FIGURES

Embodiments and experiments illustrating the principles of the invention will now be discussed with reference to the accompanying figures in which:

FIG. 1 is a schematic drawing of a dental cleaning appliance according to the present invention.

FIG. 2 is a schematic drawing of the dental cleaning appliance of FIG. 1, with the cleaning tool head of the dental cleaning appliance removed from a body of the dental cleaning appliance.

FIG. 3 is a schematic cross-sectional view through part of a dental cleaning appliance according to the present invention, showing the interaction between the field of view of an imaging sensor of the dental cleaning appliance, and a lens cover of the cleaning tool head of the dental cleaning appliance.

FIG. 4 shows (a) an isometric view; (b) a cross-sectional view; and (c) a plan view of a first lens cover as used in some embodiments of the present invention.

FIG. 5 shows (a) an isometric view; and (b) a cross-sectional view of a second lens cover as used in some embodiments of the present invention.

FIG. 6 shows (a) an isometric view; and (b) a cross-sectional view of a third lens cover as used in some embodiments of the present invention.

FIGS. 7(a)-(d) show the results of obscuration clearing tests over time, for the lens cover geometry shown in FIG. 5.

FIGS. 8(a)-(d) show the results of obscuration clearing tests over time, for the lens cover geometry shown in FIG. 4.

### DETAILED DESCRIPTION OF THE INVENTION

Aspects and embodiments of the present invention will now be discussed with reference to the accompanying figures. Further aspects and embodiments will be apparent to those skilled in the art. All documents mentioned in this text are incorporated herein by reference.

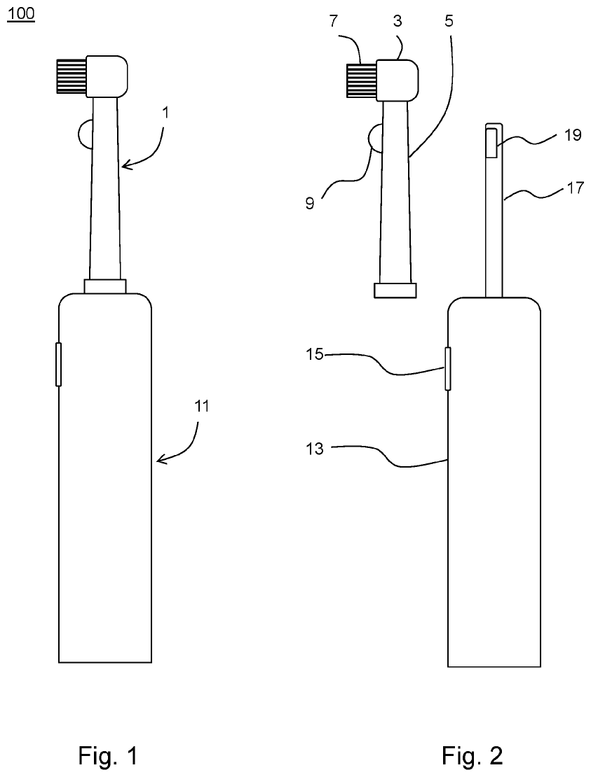

FIGS. 1 and 2 are schematic drawings of a dental cleaning appliance 100 incorporating a cleaning tool head 1 according to the present invention.

The cleaning tool 1 is, in this embodiment, a brush head comprising a head portion 3 attached to an elongate stem portion 5. The head portion comprises a plurality of bristles 7 arranged for brushing a user's teeth. The cleaning tool head further comprises a lens cover 9. The lens cover is a substantially transparent component, formed from e.g. a transparent polymeric material, or glass, which is arranged to overlay an imaging sensor of the dental cleaning device, as discussed below. The lens cover is provided on a surface of the stem portion of the cleaning tool head, and is conveniently attached using ultrasonic welding or another suitable attachment method. It can be seen that the lens cover is therefore offset from a central longitudinal axis of the brush head.

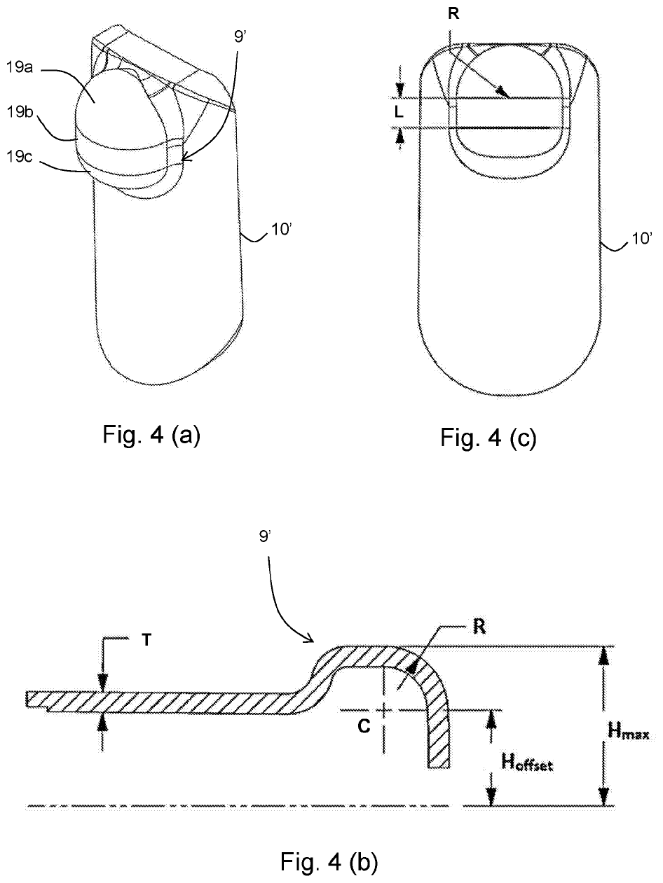

At least a portion of the outer surface of the lens cover 9 is curved. In this schematic figure, the lens cover 9 is shown as being approximately hemispherical in shape, however in practice, a wide range of geometries may be used for the lens cover-various examples of different possible lens cover geometries will be discussed below in relation to FIGS. 4, 5 and 6 but first, the overall architecture of the dental cleaning appliance will be discussed.

In addition to the cleaning tool head 1, the dental cleaning appliance 100 also comprises a body 11. The body has a handle portion 13 which is generally cylindrical in shape and which is configured to be gripped by a user during use. The handle portion 13 comprises one or more user operable controls 15, which may be operable to control e.g. a power state of the dental cleaning appliance 100, or actuation of a motor etc. of the dental cleaning appliance in a known manner. The handle further comprises a male connector in the form of a spigot 17, which extends from a first end of the handle portion 13 of the dental cleaning appliance body 11, in in a direction parallel to the longitudinal axis of the handle portion. The spigot 17 is configured to be received by a complementary female connector in the form of a recess (not shown) provided within the stem 5 of the cleaning tool head 1 (i.e. at an end of the the cleaning tool head 1 proximal to the dental cleaning appliance body), to allow for removable connection of the cleaning tool head and the dental cleaning appliance as shown in FIG. 2. The recess extends internally within the stem portion of the cleaning tool head to at least the location of the lens cover. Whilst in the embodiment shown, the cleaning tool head 1 is removably connectable to the dental cleaning appliance body, this is not essential and it is contemplated that in some arrangements, the cleaning tool head may be fixed relative to, or integral with, the dental cleaning appliance body.

The dental cleaning appliance is operable to apply a sinusoidal vibrating motion to the cleaning tool head via the spigot portion 17, by means of a motor (not shown) provided in the dental cleaning appliance body. The motor is arranged to be driven by a battery (not shown) provided in the handle portion of the dental cleaning appliance body. In this embodiment, the battery is conveniently a rechargeable battery configured for charging via a wireless battery charger in a conventional manner. The motor is configured to be actuated by a control circuit (not shown) in response to user input to the user operable control(s) 15 provided on the handle portion.

The dental cleaning appliance further comprises an imaging assembly 19 comprising an imaging sensor. In this embodiment, the imaging assembly is provided as part of the dental cleaning appliance body 3—specifically, the imaging assembly is provided within the spigot portion 17 of the dental cleaning appliance body, and arranged such that the part of the stem of the cleaning tool head which comprises the lens cover 9 is configured to overlay the imaging sensor, when the cleaning tool head is attached to the dental cleaning appliance body. This arrangement is preferred over arrangements where the imaging sensor is provided on the cleaning tool head itself, because it can allow the overall cost of the cleaning tool head to be reduced. This is advantageous as the cleaning tool head may be regularly replaced by a user of the dental cleaning appliance.

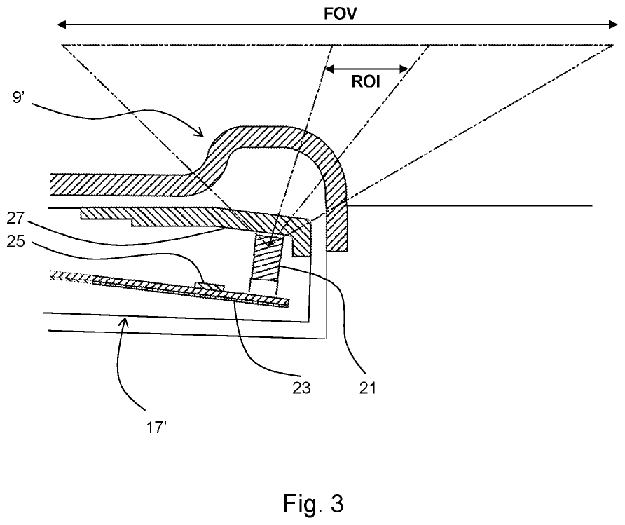

FIG. 3 is a schematic cross-sectional view through part of a dental cleaning appliance according to another embodiment of the present invention, showing the relative arrangement of an imaging sensor 21 of the dental cleaning appliance, and a lens cover 9′ of the cleaning tool head of the dental cleaning appliance. Similarly to the embodiment shown in FIGS. 1 and 2, in this embodiment, the imaging assembly in this embodiment is provided within a spigot portion 17′ of the dental cleaning appliance body. The imaging assembly comprises an imaging sensor 21 provided on a printed circuit board (PCB) 23. The imaging sensor has a defined field of view (FOV), as indicated by the outermost pair of diverging lines emanating from the imaging sensor. A region of interest (ROI) is defined within the field of view of the imaging sensor, as indicated by the innermost pair of diverging lines emanating from the imaging sensor. The ROI is smaller than the FOV, and occupies an approximately central region of the FOV.

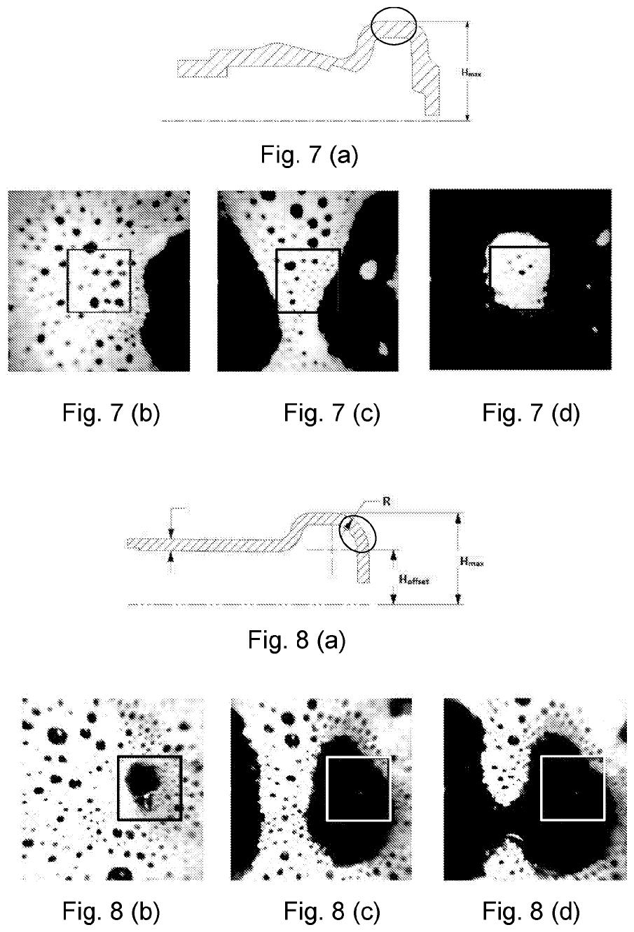

The lens cover 9′ is arranged to overlay the imaging sensor such that at least a part of the region of interest (ROI) of the imaging sensor intersects at least a part of a curved surface portion of the lens cover. In the arrangement shown, the ROI lies entirely within a curved surface portion of the lens cover—as will be seen from further detail of this specific geometry of lens cover as shown in FIG. 4, the curved surface portion of the lens cover which the ROI intersects is a domed/spherical portion. It has been found that such an arrangement can reduce or prevent unwanted obscuration of the lens cover by obscurants during use, particularly within the ROI. This will be discussed further below, in relation to FIG. 7 and FIG. 8.

A single LED 25 is provided on the PCB and arranged for illumination of at least part of the field of view of the imaging sensor, including the ROI. In this way, suitable illumination can be provided for imaging, even when the imaging sensor is used in a dark environment, such as a user's mouth. Furthermore, the use of a single LED is preferred, because this can ensure that only a low amount of heat is output by the light source, thereby reducing the risk of overheating of components located near the light source within the spigot.

A spigot lens 27 is arranged to overlay the imaging sensor 21. This spigot lens is a transparent element including an optical surface designed to be substantially neutral in distortion. It is substantially flat, in particularly in the region immediately overlying the imaging sensor.

FIGS. 4-6 each show various views of different example lens cover geometries which may be used in the present invention.

FIG. 4 shows (a) an isometric view; (b) a cross-sectional view; and (c) a plan view of a first lens cover 9′ as used in some embodiments of the present invention-this is the same lens geometry as shown in FIG. 3. The lens cover 9′ is attached to, and formed integrally with, a lens cover body 10′, which allows for convenient attachment of the lens cover to the cleaning tool head. The outer surface of the lens cover 9′ is generally domed. However, the generally domed region can be notionally subdivided into various curved surface portions have different curvatures. In the arrangement shown here, the outer surface of the lens cover can be notionally subdivided into three main curved surface portions which are arranged to overlie the FOV of the imaging sensor during use: a first curved surface portion 19a, a second curved surface portion 19b and a third curved surface portion 19c. The first to third curved surface portions are adjacent to one another along the length of the lens cover (length here being defined in relation to a longitudinal direction of the cleaning tool head of which the lens cover forms a part).

The first curved surface portion 19a is a spherical surface portion. In other words, the principle curvatures of this curved surface portion are equal to one another. The radius of curvature R in a first plane, which is a plane parallel to a longitudinal axis of the cleaning tool head, as shown in FIG. 4(b), is equal to 2.50±0.05 mm, and is equal to the radius of curvature R in a second plane as shown in FIG. 4(c), although other possible values for the radius of curvature are contemplated. The radius of curvature is measured from the centre of curvature, C, indicated in FIG. 4(b).

The second curved surface portion 19b is a cylindrical surface portion. In other words, one of the principle curvatures of the curved surface portion is equal to zero, whilst the other principle curvature has a positive value. The radius of the cylindrical portion is also equal to 2.50±0.05 mm, so that the first and second curved surface portions align. The length of the cylindrical portion, L, as measured in a direction parallel to a longitudinal direction of the cleaning tool head of which the lens cover forms a part, as shown in FIG. 4(c), is, in this arrangement, 1.4±0.1 mm, although other possible lengths are contemplated.

The third curved surface portion 19c is a domed surface portion, but is not spherical. Similarly to the first and second curved surface portions, at least one radius of curvature of the domed surface portion is equal to 2.50±0.05 mm so that the third curved surface portion.

Two values for the height of the lens cover are shown in FIG. 4(b). These are the ‘offset height’ of the lens cover (H_{offset}) and the ‘maximum height’ of the lens cover (Hₘₐₓ). Here, the height of the lens cover at any given point is given as the distance in a radial direction between a central longitudinal axis of the cleaning tool head and an outer surface of the lens cover. The central longitudinal axis of the cleaning tool head is the same as the centre of vibration of the cleaning tool head, and is indicated by the dashed line in FIG. 4(b). Accordingly, the height with respect to the central longitudinal axis is the same as the height with respect to the centre of vibration of the cleaning tool head for this arrangement.

The ‘offset height’ is defined here as the distance between the central longitudinal axis of the cleaning tool head and the centre of curvature of the first curved surface portion 19a. In this arrangement, the offset height is 3.75±0.1 mm, although other possible heights are contemplated.

The ‘maximum height’ is defined as the distance, in a radial direction, between the central longitudinal axis of the cleaning tool head and a radially outermost point of the outer surface of the lens cover. In this arrangement, the maximum height is 6.25±0.1 mm, although other possible heights are contemplated. It can be seen for this arrangement, that because the point of maximum height is located on the first curved surface portion, Hₘₐₓ=H_{offset}+R, where R is the radius of curvature of the curved surface portion. The thickness of the lens cover is, in this arrangement, approximately constant across the extent of the component. In this arrangement, the thickness of the lens cover, T, is 0.8±0.05 mm, although other possible thicknesses are contemplated.

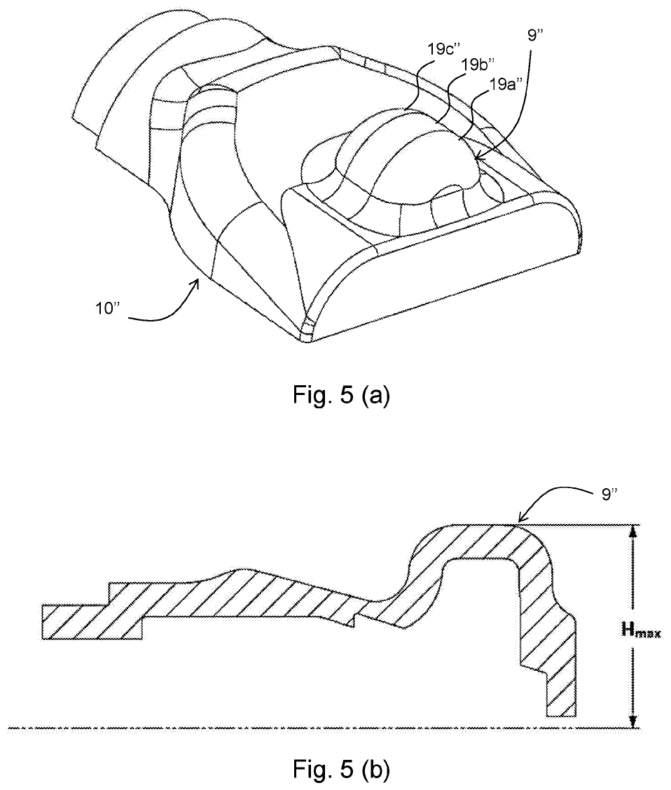

FIG. 5 shows (a) an isometric view; and (b) a cross-sectional view of a second lens cover 9″ as used in some embodiments of the present invention. Similarly to lens cover discussed in relation to FIG. 4, the lens cover 9″ in this arrangement is attached to, and formed integrally with, a lens cover body 10″, which allows for convenient attachment of the lens cover to the cleaning tool head. The lens cover 9″ in this arrangement is generally domed, and can be notionally subdivided into a first curved surface portion 19a″, a second curved surface portion 19b″ and a third curved surface portion 19c″ which are arranged to overlie the FOV of the imaging sensor during use. The first to third curved surface portions are adjacent to one another along the length of the lens cover (length here being defined in relation to a longitudinal direction of the cleaning tool head of which the lens cover forms a part). A radius of curvature of each of the three curved surface portions 19a″,b″, c″ is equal to 2.50±0.1 mm. For this lens cover, the maximum height, Hₘₐₓ is 6.1±0.1 mm, although other possible heights are contemplated.

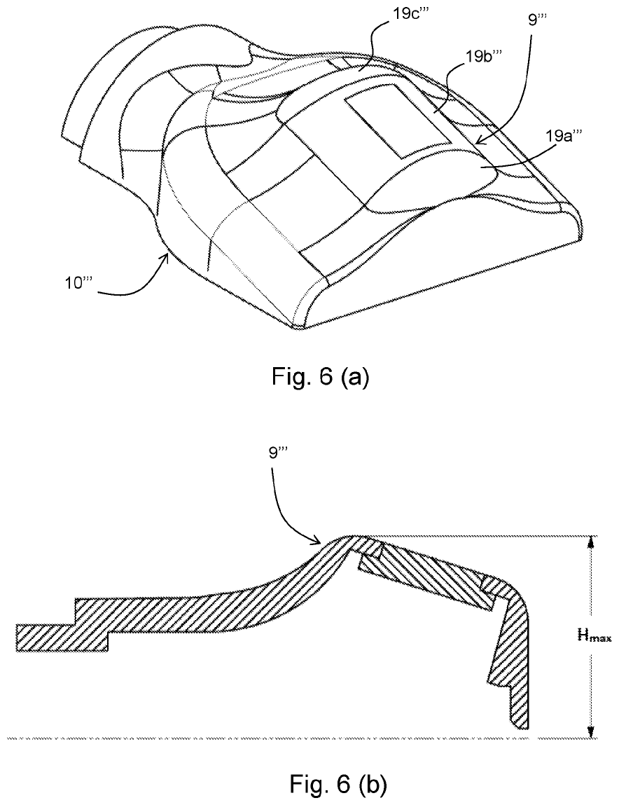

FIG. 6. shows (a) an isometric view; and (b) a cross-sectional view of a third lens cover 9′″ as used in some embodiments of the present invention. The overall shape of this lens cover differs slightly from those shown in FIGS. 4 and 5, although again, the lens cover 9′″ in this arrangement is attached to, and formed integrally with, a lens cover body 10′″, which allows for convenient attachment of the lens cover to the cleaning tool head. The lens cover 9′″ in this arrangement has a flatter profile than the lens covers shown in FIGS. 4 and 5. However, this lens cover can still be notionally subdivided into a first curved surface portion 19a′″, a second curved surface portion 19b′″ and a third curved surface portion 19c′″ which are arranged to overlie the FOV of the imaging sensor during use. Each of curved surface portions 19a′″ and 19b′″ have a radius of curvature equal to 2.50±0.1 mm. The radius of curvature of portion 19c′″ is not critical and is selected to be a convenient value. For this lens cover, the maximum height, Hₘₐₓ is about 6.25 mm, although other possible heights are contemplated.

As discussed above, it has been found that by providing a cleaning tool head having a lens cover wherein at least a part of the lens cover comprises a curved surface portion, and particularly in a region of the lens cover that is arranged to overlie the FOV of an imaging sensor during use, is particularly advantageous, because unwanted obscuration of the lens cover by obscurants such as water, salvia, toothpaste and foam can be reduced or avoided during use. In particular, unwanted obscuration of the lens cover by obscurants such as water, salvia, toothpaste and foam can be reduced or avoided in comparison to arrangements where lenses or lens covers have alternative geometries are used (for example, a flat lens, or lens cover).

To demonstrate this, some tests were performed on lens covers of various geometries, and where the FOV/ROI of an imaging sensor was aligned with different regions of curvature of the lens covers.

Obscuration tests were performed according to the following method:

### Set Up

1) The unit in test (e.g. cleaning tool head to be tested) is attached to a test device (e.g. dental cleaning appliance).
2) A sample of slurry is prepared for the test in a small pot. The slurry is made up of 6:1 ratio of water to commercially available toothpaste. The mixture is heated to 50° C. and stirred for one minute.
3) The sample of slurry is then placed below the test device with attached unit in test.
4) The test device is orientated such that the lens cover & imaging sensor are facing perpendicular to the normal of the plane the slurry is placed on. The test device is positioned in a downwards position at a 45° angle to the normal of the plane the slurry is placed on.

### Test

5) The test device is then set to oscillate. The level of oscillation is set to a desired device frequency. This value is not particularly limited but may be a value e.g. in a range of from 20 Hz to 2 MHz.
6) At least the unit in test (e.g. cleaning tool head) of the test device is then lowered into the sample of slurry and is held submerged for 5 seconds.
7) The test device is then lifted at a controlled speed vertically out of the sample of slurry.
8) The test device is then held just above the sample of slurry for 10 seconds.
9) Steps 6-8 are then repeated 30 times for the test
10) This whole test is then repeated at least 3 times to gather at least 90 submersion events.

### Analysis

11) The footage captured from the test device is analysed and the time for obscuration from slurry to clear from the ROI is measured.
12) The average of these clear times are then taken as the overall performance value of the design.

FIG. 7(a)-(d) and FIG. 8(a)-(d) show some image captures taken during such an obscuration clearing test over time, for two different geometries of lens cover. The marked square shown in FIGS. 7 (b)-(d) and 8(b)-(d) indicates the ROI within the overall FOV of the imaging sensor.

In FIG. 7(a) and FIG. 8(a), the region of intersection of the ROI with the lens cover is indicated-for FIG. 7, it can be seen that the tested lens cover has a geometry as shown in FIG. 5, and the ROI intersects the second curved surface potion of the lens cover, which is a cylindrical surface portion. For FIG. 8, it can be seen that the tested lens cover has a geometry as shown in FIG. 4, and the ROI intersects the first curved surface potion of the lens cover, which is a spherical surface portion.

The general conclusions from these tests can be summarised as follows:
Overall obscuration of the FOV of the imaging sensor is reduced over time, when the lens cover comprises one or more curved surface regions.
Where the lens cover comprises both a domed, or spherical surface region, and a cylindrical surface region, the obscuration may preferentially stagnate on the cylindrical surface region of the lens cover. Or, in other words, biased flow paths for the obscuration may be provided, which encourage clearing of regions of the lens cover adjacent to the cylindrical surface portion. Accordingly, it may be preferred to arrange the lens cover relative to the imaging sensor such that the ROI intersects a domed or spherical surface portion, and in particular, a domed or spherical surface portion that has an adjacent cylindrical portion. This can provide for improved obscuration clearance within the ROI.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about.” it will be understood that the particular value forms another embodiment. The term “about” in relation to a numerical value is optional and means for example +/−10%.

1. A cleaning tool head for a dental cleaning appliance, the cleaning tool head comprising a lens cover, wherein an outer surface of the lens cover comprises a first curved surface portion.

2. The cleaning tool head according to claim 1, wherein the principle curvatures of the curved surface portion are both greater than zero.

3. The cleaning tool head according to claim 2, wherein the principle curvatures of the curved surface portion are equal to one another.

4. The cleaning tool head according to claim 1, wherein at least one radius of curvature of the curved surface portion is in a range of from 1.5 to 4.5 mm.

5. The cleaning tool head according to claim 1, wherein the lens cover comprises a second curved surface portion immediately adjacent to the first curved surface portion, wherein the principle curvatures of the first curved surface portion differ from the principle curvatures of the second curved surface portion.

6. The cleaning tool head according to claim 5, wherein the first curved surface portion comprises a domed surface portion, and the second curved surface portion comprises a cylindrical surface portion.

7. The cleaning tool head according to claim 1, wherein the lens cover is attached to the cleaning tool head by one or more of: an adhesive, ultrasonic welding, laser welding, or an attachment structure.

8. The cleaning tool head according to claim 1, wherein a maximum height of the lens cover is in a range of from 3 to 7 mm.

9. The cleaning tool head according claim 1, wherein the cleaning tool head is a brush head comprising bristles or other elements for brushing teeth.

10. A dental cleaning appliance comprising:
a body;
an imaging sensor having a field of view; and
a cleaning tool head according to claim 1.

11. The dental cleaning appliance according to claim 10, wherein a region of interest (ROI) is defined within the field of view (FOV) of the sensor, and wherein the lens cover of the cleaning tool head is arranged to overlay the imaging sensor such that at least a part of the ROI intersects at least a part of the first curved surface portion of the lens cover, when the cleaning tool head is attached as part of the dental cleaning appliance.

12. The dental cleaning appliance according to claim 11, wherein the entire ROI intersects the first curved surface portion of the lens cover, when the cleaning tool head is attached as part of the dental cleaning appliance.

13. The dental cleaning appliance according to claim 10, wherein the dental cleaning appliance body comprises a handle portion and a spigot portion, the cleaning tool head being removably connectable to the spigot portion of the dental cleaning appliance body.

14. The dental cleaning appliance according to claim 13, wherein the imaging sensor is located within the spigot portion of the dental cleaning appliance body.

15. The dental cleaning appliance according to claim 10, wherein the imaging sensor is a camera.

16. The dental cleaning appliance according to claim 10, wherein the dental cleaning appliance further comprises a light source arranged for illumination of at least part of the field of view of the imaging sensor.

17. The dental cleaning appliance according to claim 10, wherein the dental cleaning appliance is operable to apply vibration to the cleaning tool head.

18. The dental cleaning appliance according to claim 17, wherein the vibration is sinusoidal vibration.

19. The dental cleaning appliance according to claim 17, wherein the centre of vibration lies along a longitudinal central axis of the cleaning tool head.
